(19) United States
(12) Patent Application Publication
(10) Pub. No.: US 2004/0077456 A1
(43) Pub. Date: Apr. 22, 2004

(54) Toroidal disc for traction drive device and method of producing same

(75) Inventors: Tatsuomi Nakayama, Kanagawa (JP); Minoru Ota, Kanagawa (JP); Hidenori Watanabe, Yokohama (JP); Mamoru Saito, Kanagawa (JP)

Correspondence Address: FOLEY AND LARDNER, SUITE 500, 3000 K STREET NW, WASHINGTON, DC, 20007, US

(73) Assignee: NISSAN MOTOR CO., LTD.

(21) Appl. No.: 10/661,592

(22) Filed: Sep. 15, 2003

(30) Foreign Application Priority Data
Oct. 18, 2002 (JP) 2002-303742

(51) Int. Cl. F16H 15/38

(52) U.S. Cl. 476/40

(57) ABSTRACT

For producing a toroidal disc for a traction drive device, the following steps are employed. First, a circular steel body is prepared which has been subjected to a carbonitriding hardening/tempering process. The steel body has a concentric toroidal surface which is formed with a plurality of fine recesses each having a depth of smaller than 3 μm. Then, the circular steel body is turned about a rotation axis thereof. Then, a ball member is pressed against the toroidal surface with a given pressing force. And then, the ball member is moved on a given angular range of the toroidal surface in a direction perpendicular to the rotation axis of the circular steel body while being pressed against the toroidal surface with the given pressing force.

### BACKGROUND OF THE INVENTION

1. Field of the Invention

The present invention relates in general to a toroidal disc that is a part of a traction drive type power transmission and a method of producing the toroidal disc, and more particularly to a disc having an improved operation surface and a method of producing the same.

2. Description of the Related Art

In order to clarify the task of the present invention, one known method of producing a toroidal disc for a traction drive type power transmission will be briefly described with reference to FIGS. 6 and 7 of the accompanying drawings.

That is, as is shown in FIG. 6, at step S1, through forging, a roughly shaped disc member is produced, and at step S2, through cutting, the roughly shaped disc member is shaped into a roughly shaped toroidal disc, and at step S3, the roughly shaped toroidal disc is subjected to a heat treatment, and at step S4, through grinding, the toroidal disc is formed with an operation (or toroidal) surface, and at step S5, a super finishing is applied to operation surface of the toroidal disc.

As is seen from the graph of FIG. 7, usually, the operation surface of the toroidal disc produced by the above-mentioned method has a hardness smaller than 750 Hv (Vickers hardness). However, when used in a traction drive type power transmission, the toroidal discs produced by such method inevitably have a limitation in transmitting a torque and thus tends to induce a bulky construction of the transmission. One measure for solving this drawback is disclosed in Laid-open Japanese Patent Application (Tokkai) 2002-89644. That is, in this measure, the operation surface of the toroidal disc is formed with a plurality of fine recesses or fine dimples to increase the torque transmitting ability (or traction ability) possessed by the operation surface.

### SUMMARY OF THE INVENTION

It is an object of the present invention to provide a toroidal disc and a method of producing the same, which are provided by taking the above-mentioned measure into consideration.

According to a first aspect of the present invention, there is provided a toroidal disc for a traction drive device to which a power roller frictionally contacts during operation of the traction drive device, the toroidal disc comprising a circular steel body having a concentric toroidal surface, the toroidal surface having an operative angular range that extends in a radial direction by ±25 degrees from a reference angular position which induces a speed change ratio of 1.2:1 of the traction drive device when operatively contacting the power roller, the operative angular range of the toroidal surface having a hardness of higher than 750 Hv at a depth ranging from about 50 μm to about 100 μm.

According to a second aspect of the present invention, there is provided a method of producing a toroidal disc for a traction drive device to which a power roller frictionally contacts during operation of the traction drive device, the method comprising-preparing a circular steel body that has been subjected to a carbonitriding hardening/tempering process, the steel body having a concentric toroidal surface which is formed with a plurality of fine recesses each having a depth of smaller than 3 μm; turning the circular steel body about a rotation axis thereof; pressing a ball member against the toroidal surface with a given pressing force; and moving the ball member on a given angular range of the toroidal surface in a direction perpendicular to the rotation axis of the circular steel body while pressing the ball member against the toroidal surface with the given pressing force.

According to a third aspect of the present invention, there is provided a method of producing a toroidal disc for a traction drive device to which a power roller frictionally contacts during operation of the traction drive device, the method comprising preparing a circular steel body that has been subjected to a carbonitriding hardening/tempering process, the steel body having a concentric toroidal surface; turning the circular steel body about a rotation axis thereof; pressing a ball member against the toroidal surface with a given pressing force; moving the ball member on a given angular range of the toroidal surface in a direction perpendicular to the rotation axis of the circular steel body while pressing the ball member against the toroidal surface with the given pressing force; and providing the toroidal surface with a plurality of fine recesses so that the toroidal surface has a certain surface roughness.

### BRIEF DESCRIPTION OF THE DRAWINGS

FIG. 1 is a partially sectioned plan view of a hardening device used for hardening an operation surface of a toroidal disc of the present invention;

FIG. 2 is an illustration showing the detail of a method of hardening the operation surface of the toroidal disc by using the hardening device;

FIG. 3 is a graph showing a hardness at various depths of the operation surface of the toroidal disc produced by the method of the present invention;

FIG. 4 is a graph showing a residual stress at various depths of the operation surface of the toroidal disc produced by the method of the present invention;

FIG. 5A is an illustration showing a deformation degree of an operation surface of a toroidal disc, that is caused by applying a hardening process to an entire area of the operation surface;

FIG. 5B is an illustration similar to FIG. 5A, but showing a deformation degree of an operation surface of a toroidal disc, that is caused by applying a hardening process to only a given angular range of the operation surface;

FIG. 6 is a block diagram showing a production process of a conventional toroidal disc; and

FIG. 7 is a graph showing a hardness at various depths of an operation surface of the conventional toroidal disc.

### DETAILED DESCRIPTION OF THE INVENTION

In the following, the present invention will be described in detail with reference to the accompanying drawings.

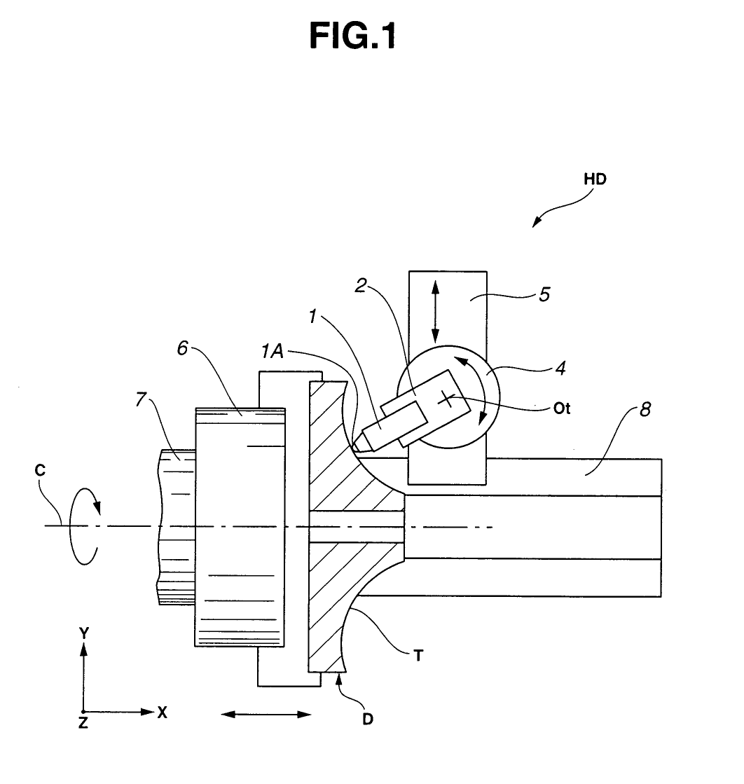

Referring to FIG. 1, there is schematically shown a hardening device HD for hardening an operation surface T of a toroidal disc D. Toroidal disc D is an input or output disc to which two power rollers (not shown) frictionally contact to constitute a traction drive type power transmission. Toroidal disc D is made of a steel (viz., SCM435H) treated with a carbonitriding hardening/tempering.

As is seen from FIG. 1, operation surface T of disc D is shaped toroidal. That is, as shown, when disc D is cut along a rotation axis C thereof, operation surface T of disc D has an arcuate contour. Operation surface T of disc D is previously formed with a plurality of fine recesses or dimples that extend around the axis of disc D, that is, around rotation axis C. More specifically, each adjacent two of the fine recesses or dimples define therebetween a fine projected portion that projects to practically contact peripheral portions of the power rollers (not shown) of the traction drive device. These fine projections and recesses (or dimples) are thus alternately arranged along a radial direction of operation surface T. In place of the recesses or dimples, a plurality of fine circular grooves extending about the rotation axis of disc D may be used. In this case, a plurality of fine projected circular ridges are formed on operation surface T of disc D, which practically contact the peripheral portions of the two power rollers.

As will be described hereinafter, to such operation surface T of disc D, a hardening process according to the present invention is applied for hardening a given angular area of operation surface T.

For ease of understanding, directional arrows X, Y and Z are provided in FIG. 1. That is, arrow X indicates a longitudinal direction of hardening device HD, and arrow Y indicates a vertical direction of hardening device HD that is perpendicular to the direction of arrow X, and arrow Z indicates a direction that is perpendicular to both the directions of arrows X and Y.

Hardening device HD comprises a main shaft 7 that is driven by an electric motor (not shown) to rotate about rotation axis C that is in parallel with the direction of arrow X. Main shaft 7 is slidable on a fixed main table 8 along rotation axis C. A chucking device 6 is mounted on main shaft 7 to chuck disc D in such a manner that disc D and main shaft 7 are arranged coaxially about rotation axis C. Thus, disc D can rotate about rotation axis together with main shaft 7 and slide axially on fixed main table 8.

Beside fixed main table 8, there is arranged a linear table 5 which mounts thereon a circular rotatable table 4. That is, circular rotatable table 4 is rotatable about an axis Ot that is parallel with the direction of arrow Z and movable on linear table 5 in a direction that is parallel with the direction of arrow Y.

On circular rotatable table 4, there is tightly mounted a tool table 2. Thus, tool table 2 is rotatable together with circular rotatable table 4 about the axis Ot. Slidably mounted on tool table 2 is a ball holder 1 of which leading end is equipped with a ball member 1A that is rotatable.

Thus, ball holder 1 is movable in the directions of the arrows X and Y, and rotatable about the axis that is parallel with the direction of arrow Z. As shown, under operation of hardening device HD, ball member 1A on ball holder 1 is pressed against operation surface T of disc D with a given force.

In the illustrated embodiment, ball member 1A is constructed of silicium-nitride. Although not shown in the drawing, a hydraulic mechanism is incorporated with ball holder 1 to bias ball member 1A against operation surface T of disc D with a given force. If desired, a roller member of silicium-nitride with a rounded periphery may be used in place of ball member 1A. For the material of ball member 1A or the roller member, ceramics, artificial diamond, hard metals and the like may be used.

In the following, description will be directed to a method that was carried out for hardening operation surface T of toroidal disc D by using the above-mentioned hardening device HD.

First, ball holder 1 (more specifically, ball member 1A held by ball holder 1) was adjusted in height and positioned with respect to operation surface T of toroidal disc D chucked by chucking device 6.

It is to be noted that toroidal disc D used has been subjected to a carbonitriding hardening/tempering treatment, and operation surface T had the above-mentioned fine recesses or dimples. Method of producing the fine recesses or dimples is described in the above-mentioned Laid-open Japanese Patent Application (Tokkai) 2002-89644. Each recess or dimple had a depth of about 3 μm. Preferably, the depth is smaller than 3 [m. The shape of the fine recess or dimple was so made as to exhibit a satisfied traction ability possessed by operation surface T.

As will be described hereinafter, such fine recesses or dimples may be formed after completion of the surface hardening process.

Operation surface T, that is, toroidal surface T of toroidal disc D was so shaped as to have an operative angular range (viz., a range of an operative angle relative to a power roller that contacts the surface T) that extends from a reference angular position of a speed change ratio of “1.2:1” by ±25 degrees. If desired, the operative angular range may extend from the reference angle of the speed change ratio of “1.2:1” by ±15 degrees and 10 degrees wherein operation surface T shows the maximum vertical interval at the reference angle of speed change ratio of “1.2:1”. Operation surface T was so shaped that the vertical interval gradually reduces with increase of distance from the reference angle.

It is to be noted that the reference angle of operation surface T differs between an input disc and an output disc to which the toroidal disc D is applicable.

By operating the hydraulic mechanism (not shown), ball member 1A was pressed against a given angular range of operation surface T of toroidal disc D, and by energizing the electric motor (not shown), main shaft 7 and thus toroidal disc D were rotated about the rotation axis C.

During rotation of toroidal disc D, circular rotatable table 4 was slowly turned about the axis Ot causing ball member 1A to describe a helical path on operation surface T of toroidal disc D. The turning of rotatable table 4 about the axis Ot may be of a one way trip, round-trip or repeated trip.

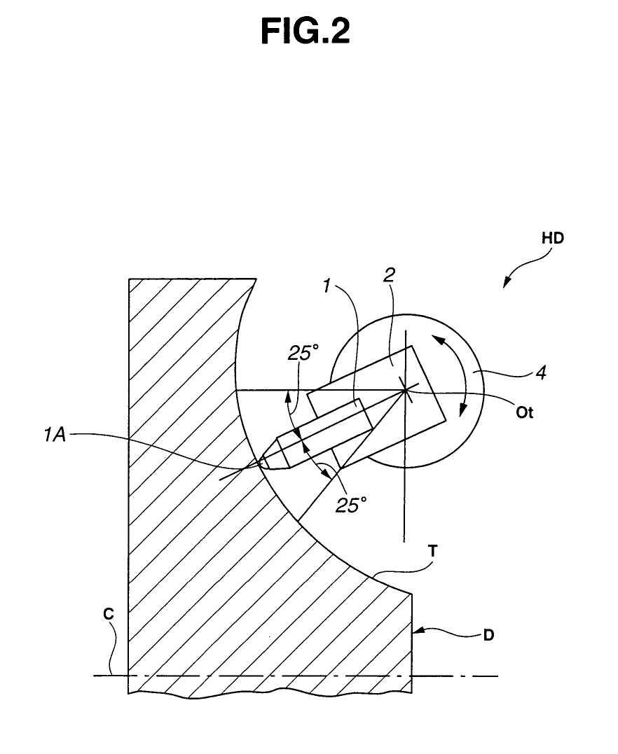

During this, due to the press work of the hydraulic mechanism (not shown) incorporated with ball holder 1, ball member 1A was kept pressed against operation surface T with a predetermined force. More specifically, as is seen from FIG. 2, during rotation of toroidal disc D, ball member 1A was caused to describe the helical path throughout the above-mentioned operative angular range.

In the illustrated embodiment, the diameter of ball member 1A was 6 mm and pressed against operation surface T of toroidal disc D with a force of about 1000 N. The rotation speed of toroidal disc D at an angular point where ball member 1A contacted operation surface T was controlled to about 250 m/min. Furthermore, a process pitch (viz., radially moved distance) of ball member 1A per each turning of toroidal disc D was controlled to a value smaller than 0.25 mm. In this case, it was revealed that during the rotation of toroidal disc D, the contact pressure of ball member 1A against operation surface T showed a value ranging from about 2.5 GPa to about 5.5 GPa.

In the present invention, the pressing force of ball member 1A against operation surface T may be a value smaller than 2000 N, the rotation speed of disc D at the angular point where ball member 1A contacts operation surface T may be about 100 m/min to 350 m/min, and the process pitch of ball member 1A may be a value smaller than 0.3 mm.

Although the rotation speed of toroidal disc D was controlled to vary depending on an angular point where ball member 1A contacts operation surface T of disc D, the rotation speed of disc D may be controlled to a fixed speed.

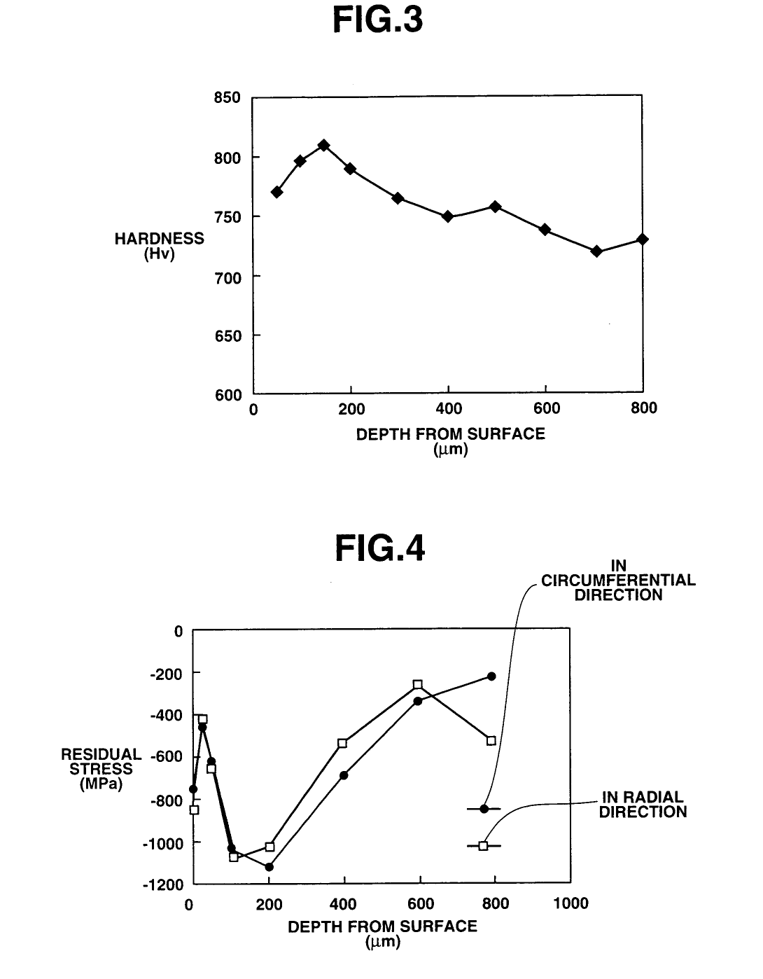

FIG. 3 is a graph showing a hardness at various depths of operation surface T of disc D, to which the above-mentioned hardening process was practically applied.

As is seen from the graph, operation surface T shows the maximum hardness of about 810 Hv at the depth of about 150 μm and shows a hardness of higher than 750 Hv at a depth ranging from about 50 μm to about 100 μm. That is, operation surface T of disc D to which the above-mentioned hardening process was applied has, in the given angular range of about 50 degrees, a sufficiently hardened surface layer from the depth of about 50 μm to the depth of about 100 μm.

FIG. 4 is a graph showing a residual stress at various depths of operation surface T of toroidal disc D, to which the above-mentioned hardening process was practically applied. As is seen from this graph, operation surface T shows the maximum residual stress of higher than about 1000 MPa in absolute value at the depth of about 150 μm and shows a residual stress of higher than about 700 MPa in absolute value at a depth ranging from about 50 μm to about 100 μm. That is, operation surface T of toroidal disc D to which the above-mentioned hardening process was applied has, in the given angular range of about 50 degrees, a surface layer with a sufficient residual stress from the depth of about 50 μm to the depth of about 100 μm.

It has been revealed that due to the above-mentioned hardening process applied to operation surface T of toroidal disc D, the hardness of operation surface T, that is, hardness of the fine projected portions defined between the recesses or dimples is remarkably increased and thus, undesired wear of operation surface T, which would be caused by a frictional contact with the two power rollers, can be reduced and thus a desired traction performance possessed by the projected portions on operation surface T can last for a longer period.

As has been mentioned hereinabove, in the method of the present invention, the hardening process is applied to only the given angular range of about 50 degrees of operation surface T of toroidal disc D. This is advantageous because a deformation of operation surface T, which would be inevitably induced by the hardening process, can be made small as will be clarified from the following description.

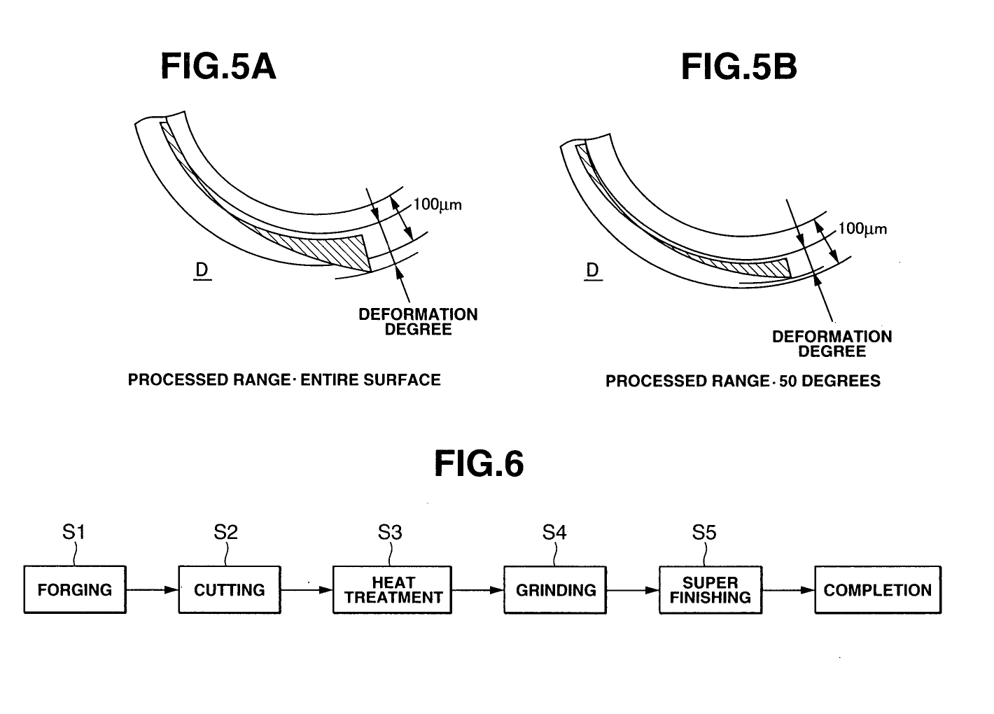

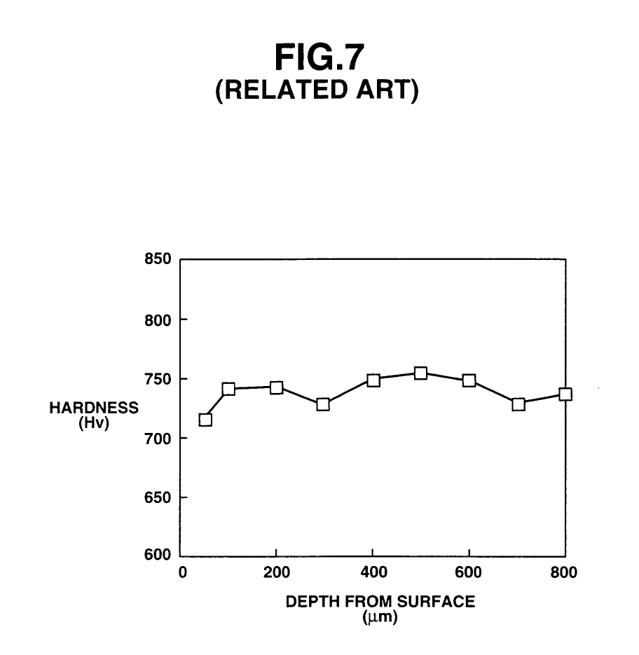

FIGS. 5A and 5B are illustrations schematically showing a deformation degree of an operation surface T of toroidal disc D. That is, in the illustration of FIG. 5A, there is shown a case wherein the hardening process was applied to an entire area of operation surface T, while, in the illustration of FIG. 5B, there is shown a case wherein the hardening process was applied to only a given angular range (viz., the angular range of 50 degrees) of operation surface T. The hatched part indicates the deformation. As is seen from these drawings, the deformation in case of the present invention (see FIG. 5B) is quite small as compare with the deformation in case of the entire hardening (see FIG. 5A). It has revealed that the deformation of the entire hardening is about 50 μm.

In the foregoing description, explanation is directed to a method for hardening operation surface T of toroidal disc D that has been previously formed with a plurality of fine recesses or dimples. However, if desired, such fine recesses or dimples may be formed after the hardening process to operation surface T is finished.

In the following, advantages of the present invention will be described.

As has been described hereinabove, the hardening process applied to operation surface T of disc D can be made by a simple and thus inexpensive hardening device such as one shown in FIG. 1. If desired, a conventional grooving device for forming grooves on operation surface T of disc D may be used as the hardening device for hardening the surface T.

In the invention, the pressing force of ball member 1A against operation surface T is controlled to a value that is smaller than 2000 N. It has revealed that such value brings about a minimized deflection of chucking device 6 and thus that of toroidal disc D held by chucking device 6.

In the invention, the contact pressure of ball member 1A applied to operation surface T during the hardening process is about 2.5 GPa to about 5.5 GPa. With this contact pressure, excessive hardening of the operation surface T is suppressed.

During the hardening process, ball member 1A, ball holder 1 and tool table 2 (see FIG. 1) are aligned on a common axis that passes through the axis Ot about which circular rotatable table 4 is turned, and thus, ball member 1A can contact operation surface T at substantially right angles inducing a stable and assured pressing to operation surface T by ball member 1A.

The entire contents of Japanese Patent Application 2002-303742 (filed Oct. 18, 2002) are incorporated herein by reference.

Although the invention has been described above with reference to the embodiments of the invention, the invention is not limited to such embodiments as described above. Various modifications and variations of such embodiments may be carried out by those skilled in the art, in light of the above description.

What is claimed is:

1. A toroidal disc for a traction drive device to which a power roller frictionally contacts during operation of the traction drive device, comprising:
a circular steel body having a concentric toroidal surface, the toroidal surface having an operative angular range that extends in a radial direction by ±25 degrees from a reference angular position which induces a speed change ratio of 1.2:1 of the traction drive device when operatively contacting the power roller, the operative angular range of the toroidal surface having a hardness of higher than 750 Hv at a depth ranging from about 50 μm to about 100 μm.

2. A toroidal disc as claimed in claim 1, in which the concentric toroidal surface is formed with a plurality of fine recesses so that the toroidal surface has a given surface roughness, each recess having a depth smaller than 3 μm.

3. A toroidal disc as claimed in claim 2, in which the operative angular range of the toroidal surface has a residual stress of higher than 700 Mpa in absolute value at the depth ranging from about 50 μm to about 100 μm.

4. A method of producing a toroidal disc for a traction drive device to which a power roller frictionally contacts during operation of the traction drive device, comprising:
preparing a circular steel body that has been subjected to a carbonitriding hardening/tempering process, the steel body having a concentric toroidal surface which is formed with a plurality of fine recesses each having a depth of smaller than 3 μm;
turning the circular steel body about a rotation axis thereof;
pressing a ball member against the toroidal surface with a given pressing force; and
moving the ball member on a given angular range of the toroidal surface in a direction perpendicular to the rotation axis of the circular steel body while pressing the ball member against the toroidal surface with the given pressing force.

5. A method as claimed in claim 4, in which the given pressing force with which the ball member is pressed against the toroidal surface is smaller than 2000N.

6. A method as claimed in claim 5, in which a mean contact pressure with which the ball member contacts the toroidal surface is a value ranging from about 2.5 GPa to about 5.5 GPa.

7. A method as claimed in claim 4, in which the given angular range of the toroidal surface extends in a radial direction by ±25 degrees from a reference angular position which induces a speed change ratio of 1.2:1 of the traction drive device when operatively contacting the power roller.

8. A method as claimed in claim 4, in which the given angular range of the toroidal surface extends in a radial direction by ±15 degrees and 10 degrees from a reference angular position which induces a speed change ratio of 1.2:1 of the traction device when operatively contacting the power roller.

9. A method as claimed in claim 4, in which the given angular range of the toroidal surface is formed with the plurality of fine recesses.

10. A method as claimed in claim 4, in which during the radial movement of the ball member on the given angular range of the toroidal surface of the toroidal disc, the ball member is urged to contact the toroidal surface at substantially right angles.

11. A method as claimed in claim 4, in which the ball member is constructed of silicium-nitride, ceramic, artificial diamond or hard metal.

12. A method as claimed in claim 11, in which a rotation speed of the toroidal disc about the rotation axis at an angular point where the ball member contacts the toroidal surface is controlled to a value ranging from about 100 m/min to about 350 m/min, and in which a process pitch of the ball member per each turning of the toroidal disc is controlled to a value smaller than 0.3 mm.

13. A method of producing a toroidal disc for a traction drive device to which a power roller frictionally contacts during operation of the traction drive device, comprising:
preparing a circular steel body that has been subjected to a carbonitriding hardening/tempering process, the steel body having a concentric toroidal surface;
turning the circular steel body about a rotation axis thereof;
pressing a ball member against the toroidal surface with a given pressing force;
moving the ball member on a given angular range of the toroidal surface in a direction perpendicular to the rotation axis of the circular steel body while pressing the ball member against the toroidal surface with the given pressing force; and
providing the toroidal surface with a plurality of fine recesses so that the toroidal surface has a certain surface roughness.
